(19) United States
(12) Patent Application Publication
(10) Pub. No.: US 2026/0037779 A1
(43) Pub. Date: Feb. 5, 2026

(54) APPARATUS AND COMPUTER-IMPLEMENTED METHOD FOR PROCESSING SENSOR DATA

(71) Applicant: Robert Bosch GmbH, Stuttgart (DE)

(72) Inventors: Martin Schiegg, Korntal-Muenchingen (DE); Sebastian Gerwinn, Leonberg (DE)

(21) Appl. No.: 19/278,124

(22) Filed: Jul. 23, 2025

(30) Foreign Application Priority Data
Aug. 5, 2024 (EP) 24 19 2947.0

(51) Int. Cl. G06N 3/0455; G01D 21/00; G06F 40/40

(52) U.S. Cl. CPC G06N 3/0455; G01D 21/00; G06F 40/40

(57) ABSTRACT

An apparatus and a computer-implemented method for processing time series of sensor data. The sensor data are provided in a first channel which includes a first time series of sensor data. A first text is assigned to the first channel which characterizes the sensor data and/or a dimension of the sensor data in the first channel. A first text coding is determined depending on the first text using a text encoder. A first channel position coding is determined depending on the first text coding using a neural network. A second text coding is determined depending on a predetermined text using a text encoder. The predetermined text characterizes sensor data to be predicted and/or a dimension of sensor data to be predicted. A second channel position coding is determined depending on the second text coding using a neural network.

### FIELD

The present invention relates to an apparatus and to a computer-implemented method for processing sensor data.

### BACKGROUND INFORMATION

To process physical variables, models such as Zhang, Yunhao, and Junchi Yan, “Crossformer: Transformer utilizing cross-dimension dependency for multivariate time series forecasting,” The Eleventh International Conference on Learning Representations, 2022, openreview.net/pdf?id=vSVLM2j9eie can be used.

If a model that has been trained on certain physical quantities, in particular multivariate time series of a certain set of physical quantities, is to be adapted to a new modeling task with changed physical quantities, until now it has been necessary to adjust many parameters by fine tuning, since different dimensions and learned dynamics do not generalize to the new physical quantities.

### SUMMARY

The present invention provides a computer-implemented method for processing sensor data, in particular time series of sensor data, provides that the sensor data are provided in a first channel, wherein the first channel comprises a first part of the sensor data, in particular a first time series of sensor data, wherein a first text is assigned to the first channel, which first text characterizes the sensor data and/or a dimension of the sensor data in the first channel, wherein a first text coding is determined depending on the first text, in particular using a text encoder, wherein a first channel position coding is determined depending on the first text coding, in particular using a neural network, wherein a second text coding is determined depending on a predetermined text, in particular using the or a text encoder, wherein the predetermined text characterizes sensor data to be predicted and/or a dimension of sensor data to be predicted, wherein a second channel position coding is determined depending on the second text coding, in particular using the or a neural network, wherein a first input variable of an encoder is determined depending on sensor data from the first channel and depending on the first channel position coding, wherein a first input variable of a decoder is determined using the encoder depending on the first input variable of the encoder, wherein a second input variable of the decoder is determined depending on the second channel position coding, and wherein sensor data, in particular a time series of sensor data, are predicted using the decoder depending on the first input variable of the decoder and the second input variable of the decoder. According to an example embodiment of the present invention, the method uses, for example, the transformer described in “In Attention Is All You Need,” arXiv:1706.03762, where the encoder is adapted to the first input variable of the encoder and the first input variable of the decoder as the output of the encoder, and the decoder is adapted to the first input variable of the decoder and the second input variable of the decoder. The neural network has for example an MLP, another transformer, or a ResNet. The text encoder is for example a pre-trained text encoder of a Large Language Model (LLM), e.g. a transformer. The text encoder is for example a pre-trained text encoder of a foundation model, e.g. word2vec or glove. The combination used in the method of text encoder, neural network, encoder and decoder represents a model. After training on training data for a modeling task, the model achieves higher accuracy using the same amount of training data for a new modeling task. After training on training data for the modeling task, the model can be adapted to the new modeling task without further training (zero-shot) or with little training data (few-shot).

The predicted sensor data can be sensor data from the first channel or a second channel.

According to an example embodiment of the present invention, the sensor data can be provided in the first channel and in the second channel, wherein the second channel comprises a second part of the sensor data, in particular a second time series of sensor data, wherein a second text is assigned to the second channel, which second text characterizes the sensor data and/or a dimension of the sensor data in the second channel, wherein a third text coding is determined depending on the second text, in particular using a text encoder, wherein a third channel position coding is determined depending on the third text coding, in particular using a neural network, wherein a second input variable of the encoder is determined depending on sensor data from the second channel and depending on the third channel position coding, wherein the first input variable of the decoder is determined using the encoder depending on the input variables of the encoder.

According to an example embodiment of the present invention, the sensor data in a particular channel characterize, for example, a physical quantity. Examples of physical quantities are current strength, voltage, resistance, temperature, humidity, gas concentration, pressure, speed, force, torque, and rotational speed. The time series represent, for example, a temporal progression of the values of the physical quantity. The text includes, for example, the name of the corresponding physical quantity. The text includes, for example, the name of the dimension of the corresponding physical quantity.

The sensor data from the first channel can be used directly to predict the sensor data, e.g., sensor data from the first or second channel.

According to an example embodiment of the present invention, a coding of sensor data from the second channel can be determined depending on sensor data from the second channel, in particular using a neural network, wherein the second input variable of the encoder is determined depending on the coding of the sensor data from the second channel and depending on the third channel position coding.

According to an example embodiment of the present invention, a coding of sensor data from the first channel is determined depending on sensor data from the first channel, in particular using a neural network, wherein the first input variable of the encoder is determined depending on the coding of the sensor data from the first channel and depending on the first channel position coding. This means that the encoded sensor data from the first channel are used to predict the sensor data, in particular the sensor data from the second channel. The neural network used to determine the coding of the sensor data comprises for example a linear layer.

According to an example embodiment of the present invention, a segment of the sensor data of the first channel can be provided for determining the first input variable of the encoder, wherein a first time indication is assigned to the segment, which first time indication characterizes a time period of the acquisition of the sensor data of the segment of the first channel, wherein a first time position coding is determined depending on the first time indication, in particular using a neural network, and wherein the first input variable of the encoder is determined depending on the sensor data from the segment of the sensor data of the first channel and depending on the first channel position coding and depending on the first time position coding. This means that the prediction of the sensor data is based on the sensor data collected in the time period defined by the first time indication. The neural network used to determine the first time position encoding comprises for example a linear layer.

The sensor data from the segment of the first channel can be used directly to predict the sensor data from the segment, in particular of the second channel.

According to an example embodiment of the present invention, a coding of sensor data from the first channel can be determined depending on sensor data from the first channel, in particular using a neural network, wherein the first input variable of the encoder is determined depending on the coding of the sensor data from the segment of the sensor data of the first channel and on the first channel position coding and on the first time position coding. This means that the encoded sensor data from the segment of the first channel is used to predict the sensor data, in particular the sensor data from the segment of the second channel. The neural network used to determine the coding of the sensor data from the segment comprises for example a linear layer.

Sensor data can be determined from a segment of the predicted sensor data using the decoder, wherein a second time indication is assigned to the segment of the predicted sensor data, which second time indication characterizes a time period of the sensor data in the segment of the predicted sensor data, wherein a second time position coding is determined depending on the second time indication, in particular using the same neural network with which the first time position coding is determined, or using a neural network, and wherein the second input variable of the decoder is determined depending on the second channel position coding and depending on the second time position coding. This means that the prediction is determined for the sensor data in the time period defined by the second time indication. The neural network used to determine the second time position coding comprises for example a linear layer.

A user input comprising the second time indication can be recorded. The user input specifies for which segment the prediction of the sensor data is determined.

For example, the time indication can characterize a start and an end of the time period, or the time indication can include a point in time or time index that is assigned to the time period.

A reference can be provided for the predicted sensor data, in particular sensor data from the second channel, wherein the encoder and/or the decoder are trained depending on a difference between the reference and the predicted sensor data and/or wherein an anomaly is detected or a calibration is carried out depending on a difference between the reference and the predicted sensor data. The training trains the model for a modeling task. The difference between the acquired sensor data contained in the second channel and the sensor data predicted for the second channel makes it possible to detect an anomaly or perform a calibration.

A user input comprising the specified text can be detected. The user input specifies which sensor data are predicted.

The predicted sensor data can be output; in particular, the predicted time series is output. The output sensor data represent a prediction of sensor data from a non-measurable channel or the second channel.

According to an example embodiment of the present invention, an apparatus for processing sensor data, in particular time series of sensor data, provides that the apparatus comprises at least one processor and at least one memory, wherein the at least one processor is designed to execute instructions, upon execution of which the apparatus executes the method according to the present invention, wherein the memory stores the instructions.

A computer program of the present invention comprises computer-executable instructions, upon execution of which by the computer the computer executes the method of the present invention.

Further examples can be found in the following description and the figures.

### BRIEF DESCRIPTION OF THE DRAWINGS

FIG. 1 is a schematic representation of an apparatus for processing sensor data, according to an example embodiment of the present invention.

FIG. 2 is a schematic representation of sensor data, according to an example embodiment of the present invention.

FIG. 3 is a schematic representation of a first part of a model for processing the sensor data, according to an example embodiment of the present invention.

FIG. 4 is a schematic representation of a second part of the model, according to an example embodiment of the present invention.

FIG. 5 is a schematic representation of a third part of the model, according to an example embodiment of the present invention.

FIG. 6 is a flow diagram with steps of a first example of a method for processing sensor data, according to the present invention.

FIG. 7 is a flow diagram with steps of a second example of the method for processing sensor data, according to the present invention.

### DETAILED DESCRIPTION OF EXAMPLE EMBODIMENTS

FIG. 1 schematically shows an apparatus 100 for processing sensor data. The apparatus 100 comprises at least one processor 102 and at least one memory 104.

The at least one processor 102 is designed to execute machine-readable instructions upon the execution of which the apparatus 100 executes a method for determining the classification. The at least one memory 104 is designed to store the instructions.

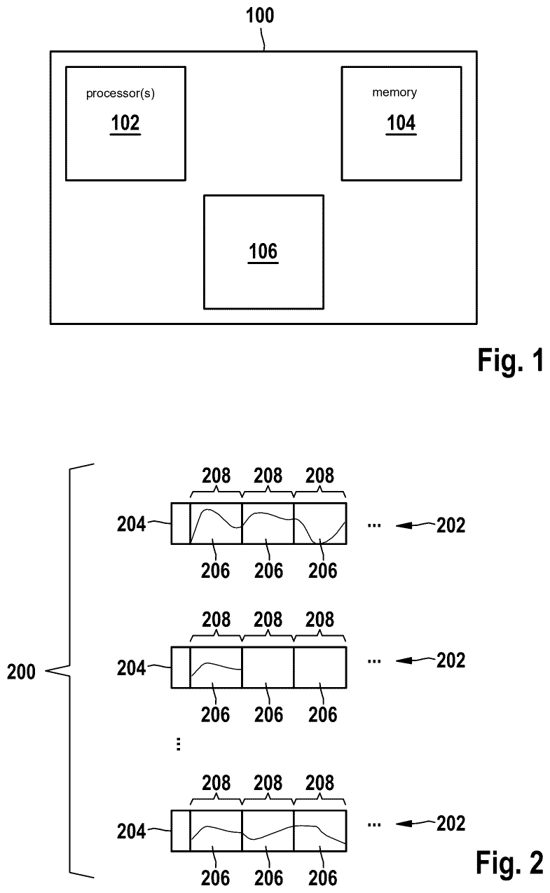

FIG. 2 schematically shows sensor data 200.

The sensor data 200 are for example time series of sensor data. The time series are for example multivariate time series.

Multivariate time series consist of a large number of univariate time series data. The multivariate time series comprise for example a plurality of physical quantities that were measured simultaneously over a time course. The univariate time series each comprise for example a single physical quantity that was measured over the time course.

A multivariate time series x_{1:T,1:D}∈R^{D×T} of length T and D sensor data, e.g. D physical quantities, is given e.g. as

$${x}_{1 : T , 1 : D} = \{ {x}_{t , d} \vert 1 \leq t \leq T , 1 \leq d \leq D \}$$

The sensor data 200 are provided in channels 202. That is, the multivariate time series comprises D channels d.

The channels 202 each comprise a part of the sensor data 200.

For example, a first channel comprises a first part of the sensor data 200. In the example, the sensor data in the first part of the sensor data characterize a first physical quantity. The first channel 202 comprises, for example, a first time series of sensor data 200.

For example, a second channel comprises a second part of the sensor data 200. In the example, the sensor data in the second part of the sensor data characterize a second physical quantity. The second channel 202 comprises for example a second time series of sensor data 200.

The sensor data 200 in a first segment of the first channel 202 are known in the example. The sensor data in a second segment and a third segment of the first channel 202, which follow the first segment of the first channel 202, are known in the example.

The sensor data 200 in a first segment of the second channel 202 are known in the example. The sensor data in a second segment and in a third segment of the second channel 202, which follow the first segment of the second channel 202, are unknown in the example.

The sensor data 200 in a first segment of a third channel 202 are known in the example. The sensor data in a second segment and in a third segment of the third channel 202, which follow the first segment of the third channel 202, are known in the example.

In the example, the first segment of each channel includes sensor data acquired during the same time period. In the example, the subsequent segments have the same length as the time period of the first segments.

A text 204 is assigned to each channel, which text characterizes the sensor data in the corresponding channel and/or a dimension of the sensor data in the corresponding channel.

For example, a first text 204 is assigned to the first channel 202, which first text characterizes the sensor data and/or a dimension of the sensor data in the first channel 202.

For example, a second text 204 is assigned to the second channel 202, which second text characterizes the sensor data and/or a dimension of the sensor data in the second channel 202. The sensor data 202 can comprise more than two channels, in particular for more than two different physical quantities, wherein a text 204 is provided in each case.

The sensor data 200 is divided into segments. FIG. 2 shows exemplary segments 206 of the sensor data 200. The segments 206 each comprise parts of the sensor data 200 from one of the channels, in particular parts of the time series of the corresponding channel.

The segments 206 each comprise the sensor data 200 from a time period 208. In the example, segments 206 are provided, each comprising a time period 208 of the same duration.

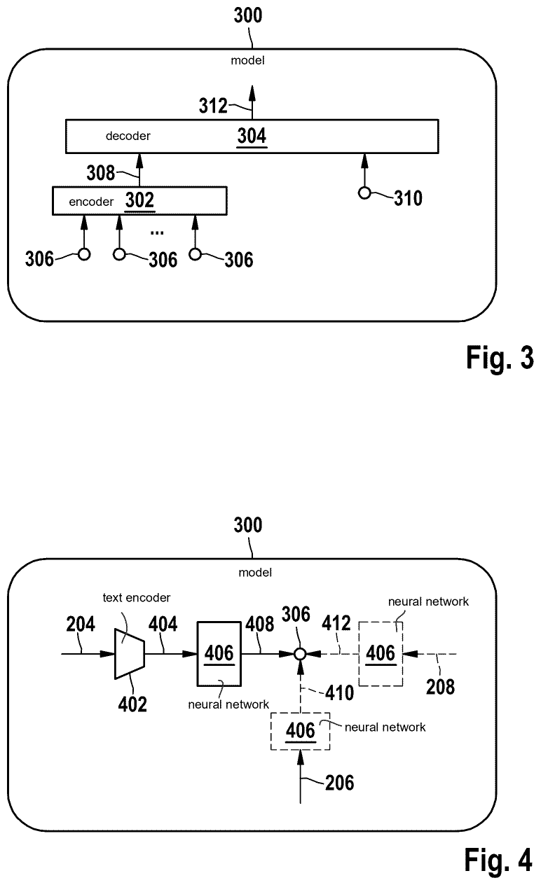

FIG. 3 schematically shows a first part of a model 300 for processing the sensor data.

The model 300 includes an encoder 302 and a decoder 304.

For example, the encoder 302 and the decoder 304 are designed as for the encoder and decoder of the transformer described in “In Attention Is All You Need,” arXiv:1706.03762.

The encoder 302 is designed to map one input variable 306 or multiple input variables 306 of the encoder 302 to one output variable of the encoder 302 or multiple output variables of the encoder 302. For example, the encoder 302 is designed to map the input variables 306 to as many output variables of the encoder 302 as there are input variables 306. A first input variable 308 of the decoder comprises the output variable or output variables of the encoder 302.

The decoder 304 is designed to map the first input variable 308 and one or more second input variables 310 of the decoder to a prediction for sensor data 312. This means that sensor data 312 can be predicted using the decoder 304.

The decoder 304 determines the prediction for sensor data 312, e.g. for a single segment or multiple segments. For example, as many second input variables 310 are provided as there are segments in the sensor data that are unknown and therefore to be predicted. The prediction for the sensor data 312 comprises, for example, exactly as many segments as the number of provided second input variables 310.

For example, the decoder 304 is designed to predict a set of segments specified over any combination of time points and physical quantities.

The multivariate time series x_{1:7,1:D} Can comprise one segment or can be divided into a plurality of segments L_{seg}.

The multivariate time series x_{1:7,1:D} is for example decomposed per dimension d, i.e. per channel 202, into T/L_{seg} segments L_{seg}. These are notated with

$${x}_{i , d}^{( s )}$$

where i denotes the i-th segment and d denotes the d-th channel 202.

FIG. 4 schematically shows a second part of the model 300.

The second part of the model 300 includes a text encoder 402. The text encoder 402 is designed to determine a text encoding 404 depending on the text 204.

The second part of the model 300 includes a neural network 406. The neural network 406 is designed to determine a first channel position coding 408 depending on the first text coding 404.

The second part of the model 300 is designed to determine the input variable 306 of the encoder 302 depending on a segment 206 from a channel 202 of the sensor data 200 and depending on the channel position coding 408 of the channel 202 from which the segment 206 originates.

Optionally, the second part of the model 300 comprises a neural network 406 that is designed to map the segment 206 to a coding 410 of the segment 206. The second part of the model 300 is designed for example to determine the input variable 306 of the encoder 302 depending on the coding 410 of the segment 206 and depending on the channel position coding 408 of the channel 202 from which the segment 206 originates.

Optionally, the second part of the model 300 comprises a neural network 406 that is designed to map the time period 208 of the segment 206 for which the channel position coding 408 is determined to a time position coding 412.

The second part of the model 300 can be designed to determine the input variable 306 of the encoder 302 depending on the coding 410 of the segment 206 and depending on the channel position coding 408 of the channel 202 from which the segment 206 originates, and depending on the time position coding 412 of the time period 208 of the segment 206 for which the channel position coding 408 is determined.

The second part of the model 300 can be designed to determine the input variable 306 of the encoder 302 depending on the segment 206 and depending on the channel position coding 408 of the channel 202 from which the segment 206 originates, and depending on the time position coding 412 of the time period 208 of the segment 206 for which the channel position coding 408 is determined.

The input variable 306 of the encoder 302 is, for example, determined independently of the time position coding 412 for the segments

$${x}_{i , d}^{( s )}$$

as follows:

$${h}_{i , d} = E \cdot {x}_{i , d}^{( s )} + f ( {e}_{{s}_{d}} )$$

where h_{i,d} represents the input variable 306 in an embedding space of the encoder 302, E represents a learnable matrix with a size appropriate to the length of the segments

$${x}_{i , d}^{( s )}$$

and the dimension of the embedding space,

$$E \cdot {x}_{i , d}^{( s )}$$

represents a projection of the value progression of the values of the univariate time series in the segment

$${x}_{i , d}^{( s )}$$

into the empeading space, eₛ_{_{d}} represents the text encoding 404, f represents a neural network for mapping the text encoding 404 into the embedding space.

The input variable 306 of the encoder 302 is, for example, determined for the segments

$${x}_{i , d}^{( s )}$$

as follows:

$${h}_{i , d} = E \cdot {x}_{i , d}^{( s )} + f ( t , {e}_{{s}_{d}} )$$

where h_{i,d} represents the input variable 306 into the embedding space of the encoder 302, E represents the learnable matrix, E·

$${x}_{i , d}^{( s )}$$

represents the projection of the value progression of the values of the univariate time series in the segment

$${x}_{i , d}^{( s )}$$

into the embedding space, t represents the time position coding 412, eₛ_{_{d}} represents the text encoding 404, f represents a neural network for mapping the time position coding 412 and the text coding 404 into the embedding space.

The input variable 306 of the encoder 302 is determined, for example, as follows:

$${h}_{i , d} = T ( {x}_{i , d}^{( s )} ) + f ( {t}_{start} , {t}_{end} , {e}_{{s}_{d}} )$$

where h_{i,d} represents the input variable 306 in the embedding space of the encoder 302, T(⋅) represents an operator, eₛ_{_{d}} represents the text encoding 404, f represents a neural network for mapping a start time tₛₜₐᵣₜ and an end time t_{end} of the segment

$${x}_{i , d}^{( s )}$$

and of the text encoding 404 into the embedding space.

The operator T(⋅) is designed to work with different lengths of the segments

$${x}_{i , d}^{( s )}$$

efficiently and maps to a vector in the embedding space of the encoder 302. For example, the operator T(⋅) is implemented as a transformer, which first maps the value progression within a segment to a sequence of embeddings and then maps these embeddings to a vector via a mean-aggregation. For example, the operator is a recursive neural network (RNN), which maps the value progression within a segment to a last hidden state. For example, the operator is a multilayer perceptron (MLP) which comprises filling with zeros, i.e. zero-padding, to a given length.

The input variable 306 of the encoder 302 is determined, for example, as follows:

$${h}_{i , d} = r ( {e}_{{s}_{d}} , {t}_{start} , {t}_{end} , {x}_{i , d}^{( s )} )$$

where r(⋅) represents a non-linear combination of the text encoding 404 represented by eₛ_{_{d}}, of a start time tₛₜₐᵣₜ and an end time t_{end} of the corresponding segment

$${x}_{i , d}^{( s )} ,$$

and of

$${x}_{i , d}^{( s )} .$$

The nonlinear combination r(⋅) is implemented for example as a neural network, in particular a transformer.

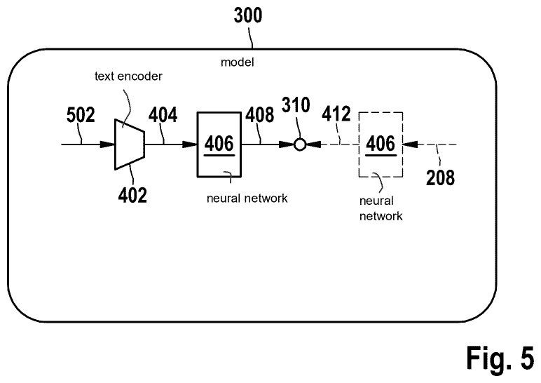

FIG. 5 schematically shows a third part of the model 300.

The third part of the model 300 comprises a text encoder 402. The text encoder 402 is designed to map a predetermined text 502 onto a text encoding 404. The predetermined text 502 characterizes the sensor data 312 to be predicted and/or a dimension of the sensor data 312 to be predicted. The third part of the model 300 comprises a neural network 406 which is designed to map the text encoding 404 onto a channel position encoding 408. The third part of the model 300 is designed to determine the second input variable 310 of the decoder 304 depending on the channel position coding 408.

Optionally, the third part of the model 300 comprises a neural network 406 which is designed to map the time period 208 of a segment 206, for which the sensor data 312 are to be predicted with the decoder 304, onto a time position coding 412. The third part of the model is designed for example to determine the second input variable 310 of the decoder 304 depending on the channel position coding 408 and the time position coding 412.

The second input variable 310 is determined for example independently of the time position coding 412 as follows:

$${v}_{i , d} = f ( {e}_{{s}_{d}} )$$

where v_{i,d} represents the second input variable 310 in an embedding space, of the decoder 304, eₛ_{_{d}} represents the text encoding 404, f represents a neural network for mapping the text encoding 404 into the embedding space.

The second input variable 310 of the decoder 304 is determined for example depending on the time position coding 412 as follows:

$${v}_{i , d} = f ( t , {e}_{{s}_{d}} )$$

where v_{i,d} represents the second input variable 310 in the embedding space of the decoder 304, t represents the time position coding 412, eₛ_{_{d}} represents the text encoding 404, f represents a neural network for mapping the time position coding 412 and the text coding 404 into the embedding space.

The second input variable 310 of the decoder 304 is determined, for example, as follows:

$${v}_{i , d} = f ( {t}_{start} , {t}_{end} , {e}_{{s}_{d}} )$$

where v_{i,d} represents the second input variable 310 in the embedding space of the decoder 304, eₛ_{_{d}} represents the text encoding 404, f represents a neural network for mapping a start time tₛₜₐᵣₜ and an end time t_{end} of the segment

$${x}_{i , d}^{( s )}$$

and the text encoding 404 into the embedding space.

The second input variable 310 of the decoder 304 is determined, for example, as follows:

$${v}_{i , d} = r ( {e}_{{s}_{d}} , {t}_{start} , {t}_{end} , {x}_{i , d}^{( s )} )$$

where r(⋅) represents a non-linear combination of the text encoding 404 represented by eₛ_{_{d}} of a start time tₛₜₐᵣₜ and an end time t_{end} of the corresponding segment

$${x}_{i , d}^{( s )} ,$$

and of

$${x}_{i , d}^{( s )} .$$

The nonlinear combination r(⋅) is implemented for example as a neural network, in particular a transformer.

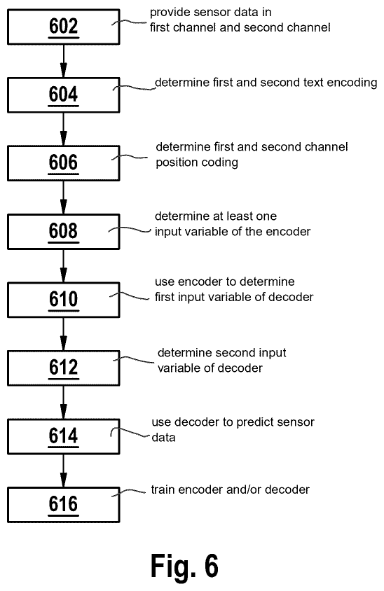

FIG. 6 shows a flow diagram with steps of a first example of a method for processing sensor data. The first example does not provide time position coding. For example, for sensor data 200 from a time period, the sensor data contained in the channels from the sensor data 200 from the entire time period are processed using the method according to the first example.

The method is described for two channels 202, the first channel 202 and the second channel 202. The method is described using the example of a prediction of sensor data from the second channel 202 depending on the sensor data from the first channel 202.

For the example, the encoder 302 includes an input 306.

The method is applicable for more than two channels 202. For each channel 202 taken into account in the method, a corresponding input 306 of the encoder 302 is provided. The method is carried out on the channels 202 taken into account, as described for the first channel 202.

The method is applicable for a prediction of sensor data from the second channel 202, taking into account the sensor data from the second channel 202. The method is applicable for predicting sensor data that are not contained in one of the channels.

The method according to the first example comprises a step 602.

In step 602, the sensor data 200 are provided in the first channel 202 and the second channel 202. In the example, the sensor data 200 in the second channel 202 are a reference for the sensor data 312 to be predicted.

The first text 204 is assigned to the first channel 202. The first text 204 characterizes the sensor data 200 and/or the dimension of the sensor data 200 in the first channel 202.

The second text 204 is assigned to the second channel 202. The second text 204 characterizes the sensor data 200 and/or the dimension of the sensor data 200 in the second channel 202.

The method according to the first example comprises a step 604.

In step 604, the first text encoding 404 is determined depending on the first text 204, in particular with the text encoder 402.

In step 604, a second text encoding 404 is determined depending on the predetermined text 502, in particular with the text encoder 402.

The predetermined text 502 characterizes the sensor data 312 to be predicted and/or the dimension of the sensor data 312 to be predicted.

For example, the predetermined text 502 is acquired in a user input.

In the example, the predetermined text 502 characterizes the sensor data 200 in the second channel 202.

In the example, the predetermined text 502 is the text 204, which is assigned to the second channel 202 of the sensor data 200. The predetermined text 502 can be another text that characterizes the sensor data or the dimension of the sensor data from the second channel 202.

To predict sensor data other than the sensor data contained in one of the channels 202 of the sensor data 200, the predetermined text 502 can be a text that characterizes the other sensor data or the dimension of the sensor data.

The method according to the first example comprises a step 606.

In step 606, a first channel position coding 408 is determined depending on the first text coding 404, in particular with the neural network 406.

In step 606, a second channel position coding 408 is determined depending on the second text coding 404, in particular with the neural network 406.

The method according to the first example comprises a step 608.

In step 608, at least one input variable 306 of the encoder 302 is determined.

For example, an input variable 306 of the encoder 302 is determined for each channel 202 that is taken into account.

In the example, the first channel 202 is taken into account.

Depending on the sensor data 200 from the first channel 202 and depending on the first channel position coding 408, an input variable 306 of the encoder 302 is determined. Optionally, the input variables 306 for the first encoder 302 are determined depending on the coding of the sensor data from the first channel 202 and depending on the first channel position coding 408. The sensor data from the first channel 202 are mapped, for example with the neural network 406, to the coding of the sensor data from the first channel 202.

The method according to the first example comprises a step 610.

In step 610, the encoder 302 is used to determine the first input variable 308 of the decoder 304 depending on the input variables 306 of the encoder 302.

If multiple channels 202 are taken into account, the first input variable 308 of the decoder 304 is determined with the encoder 302 depending on the input variables 306 of the encoder 302 determined for the multiple channels 202.

The method according to the first example comprises a step 612.

In step 612, the second input variable 310 of the decoder 304 is determined.

The second input variable 310 is determined depending on the second channel position coding 408.

The method according to the first example comprises a step 614.

In step 614, the decoder 304 is used to predict the sensor data 312, in particular the time series of sensor data 312, depending on the first input variable 308 and the second input variable 310.

In the example, the sensor data 312 for the second channel 502 are predicted.

The method according to the first example optionally comprises a step 616.

In step 616, a training of the encoder 302 and/or the decoder 304 can be provided.

For example, the encoder 302 and/or the decoder 304 is trained depending on a difference between the reference and the predicted sensor data 312.

In step 616, an anomaly detection can be provided.

For example, the anomaly is detected depending on a difference between the reference and the predicted sensor data 312. The anomaly is detected, for example, if the difference is greater than a threshold value. The difference is, for example, a mean deviation between values of the time series of the reference and values of the time series of the predicted sensor data 312.

In step 616, a calibration can be provided.

The calibration is performed, for example, depending on the difference between the reference and the predicted sensor data 312.

In step 616, an output of the predicted sensor data 312 can be provided. For example, the predicted time series is output.

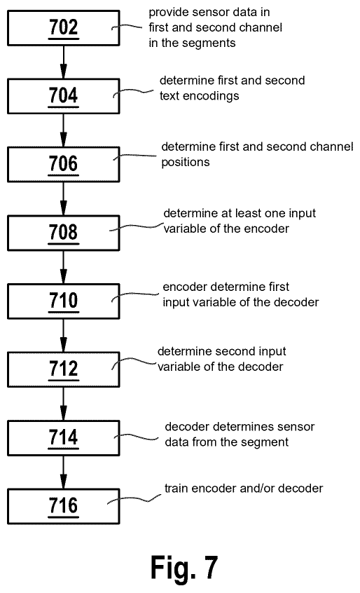

FIG. 7 shows a flow diagram with steps of a second example of the method for processing sensor data. The second example provides a time position coding.

The method according to the second example comprises a step 702.

In step 702, the sensor data 200 are provided in the first channel 202 and in the second channel 202 in the segments 206.

In step 702, a first time indication is provided which characterizes a time period 208 of the acquisition of the sensor data 200 of a segment 206 of the first channel that is to be taken into account for the prediction of the sensor data 312.

In the example, the first time indication is provided, which characterizes the first segment of the first channel 202.

In addition, in step 702, a second time indication is provided which indicates which time period 208 the sensor data 312 are to be predicted in.

In the example, the second time indication is provided, which characterizes the time period of the second segment 206 of the second channel 202.

The first time indication and/or the second time indication are acquired for example in a user input.

The time indication characterizes for example a start and an end of the period 208. The time indication includes, for example, a point in time or time index that is assigned to the time period 208.

The method according to the second example comprises a step 704.

In step 704, the first text encoding 404 is determined depending on the first text 204, in particular with the text encoder 402.

In step 704, a second text encoding 404 is determined depending on the predetermined text 502, in particular with the text encoder 402.

The predetermined text 502 characterizes the sensor data 312 to be predicted and/or the dimension of the sensor data 312 to be predicted.

For example, the predetermined text 502 is acquired in a user input.

In the example, the predetermined text 502 characterizes the sensor data 200 in the second channel 202.

In the example, the predetermined text 502 is the text 204, which is assigned to the second channel 202 of the sensor data 200. The predetermined text 502 can be another text that characterizes the sensor data or the dimension of the sensor data from the second channel 202.

For the prediction of sensor data other than the sensor data contained in one of the channels 202 of the sensor data 200, the predetermined text 502 can be a text that characterizes the other sensor data or the dimension of the sensor data. This is possible for example if the model was previously trained on training data that include the other sensor data for the prediction of this other sensor data.

The method according to the second example comprises a step 706.

In step 706, a first channel position coding 408 is determined depending on the first text coding 404, in particular with the neural network 406.

In step 706, a second channel position coding 408 is determined depending on the second text coding 404, in particular with the neural network 406.

In step 706, a first time position coding 412 is determined depending on the first time indication, in particular with the neural network 406.

In step 706, a second time position coding 412 is determined depending on the second time indication, in particular with the same neural network 406 with which the first time position coding 412 is determined, or with a different neural network 406.

The method according to the second example comprises a step 708.

In step 708, at least one input variable 306 of the encoder 302 is determined.

For example, an input variable 306 of the encoder 302 is determined for each channel 202 that is taken into account.

In the example, the first channel 202 is taken into account.

Depending on the sensor data 200 from the first channel 202 and depending on the first channel position coding 408 and depending on the first time position coding 412, an input variable 306 of the encoder 302 is determined. Optionally, it is provided that the input variables 306 for the first encoder 302 are determined depending on the coding of the sensor data from the first channel 202 and depending on the first channel position coding 408 and depending on the first time position coding 412. The sensor data from the first channel 202 are mapped, for example with the neural network 406, to the coding of the sensor data from the first channel 202.

The method according to the second example comprises a step 710.

In step 710, the encoder 302 determines the first input variable 308 of the decoder 304 depending on the input variables 306 of the encoder 302.

If multiple channels 202 are taken into account, the first input variable 308 of the decoder 304 is determined with the encoder 302 depending on the input variables 306 of the encoder 302 determined for the multiple channels 202.

The method according to the second example comprises a step 712.

In step 712, the second input variable 310 of the decoder 304 is determined.

The second input variable 310 is determined depending on the second channel position coding 408 and depending on the second time position coding 412.

The method according to the second example comprises a step 714.

In step 714, the decoder 304 determines the sensor data 312 from the segment 206 of the predicted sensor data 312 associated with the second time indication.

An individual channel 202 can be taken into account. For example, sensor data 200 from the individual channel 202 are predicted from known sensor data 200 from the individual channel. For example, future sensor data 200 for the individual channel 202 are predicted from past sensor data 200 from the individual channel 202. For example, to reconstruct sensor data 200 of the individual channel 202 from known sensor data 200 from the individual channel 202, unknown sensor data 200 for the individual channel 202 are predicted. The sensor data 200 for the individual channel 202 can be predicted as a whole or for particular segments of the sensor data 200 from the individual channel 202. The sensor data 200 for the individual channel 202 can be predicted depending on the sensor data 200 from the individual channel 202 as a whole or depending on one or more segments of the sensor data 200 from the individual channel 202.

This means that instead of the sensor data 200 from the first channel 202 and the second channel 202, the sensor data 200 from the individual channel 202 are provided.

If the individual channel 202 is taken into account, the first input variable 308 of the decoder 304 is determined with the encoder 302 depending on the input variable 306 of the encoder 302 determined for the individual channel.

The sensor data 200 can be predicted simultaneously at individual, in particular different, points in time or for different channels 202.

For example, future sensor data 200, i.e. not-yet-measured sensor data 200, are predicted from a plurality of channels 202, in particular from the first channel 202 and the second channel 202 simultaneously.

1-14. (canceled)

15. A computer-implemented method for processing time series of sensor data, the method comprising the following steps:
providing the sensor data in a first channel, wherein the first channel includes a first time series of the sensor data;
assigning a first text to the first channel, the first text characterizing the sensor data and/or a dimension of the sensor data in the first channel;
determining a first text coding depending on the first text, using a text encoder;
determining a first channel position coding depending on the first text coding, using a neural network;
determining a second text coding depending on a predetermined text, using the text encoder, wherein the predetermined text characterizes sensor data to be predicted and/or a dimension of the sensor data to be predicted;
determining a second channel position coding depending on the second text coding, using the neural network;
determining a first input variable of an encoder depending on the sensor data from the first channel and depending on the first channel position coding;
determining a first input variable of a decoder, using the encoder, depending on the first input variable of the encoder;
determining a second input variable of the decoder depending on the second channel position coding; and
predicting a time series of sensor data using the decoder depending on the first input variable of the decoder and the second input variable of the decoder.

16. The computer-implemented method according to claim 15, wherein the sensor data are provided in the first channel and in a second channel, wherein the second channel includes a second time series of sensor data, wherein a second text is assigned to the second channel, which characterizes the sensor data and/or a dimension of the sensor data in the second channel, wherein a third text coding is determined depending on the second text, using the text encoder, wherein a third channel position coding is determined depending on the third text coding, using a neural network, wherein a second input variable of the encoder is determined depending on the sensor data from the second channel and depending on the third channel position coding, wherein the first input variable of the decoder is determined using the encoder depending on the input variables of the encoder.

17. The computer-implemented method according to claim 16, wherein a coding of the sensor data from the second channel is determined depending on the sensor data from the second channel, using the neural network, wherein the second input variable of the encoder is determined depending on the coding of the sensor data from the second channel and depending on the third channel position coding.

18. The computer-implemented method according to claim 16, wherein a coding of the sensor data from the first channel is determined depending on the sensor data from the first channel, using the neural network, wherein the first input variable of the encoder is determined depending on the coding of the sensor data from the first channel and depending on the first channel position coding.

19. The computer-implemented method according to claim 15, wherein a segment of the sensor data of the first channel is provided for determining the first input variable of the encoder, wherein a first time indication is assigned to the segment, the first time indication characterizing a time period of acquisition of the sensor data of the segment of the first channel, wherein a first time position coding is determined depending on the first time indication, using the neural network, and wherein the first input variable of the encoder is determined depending on the sensor data from the segment of the sensor data of the first channel and depending on the first channel position coding and depending on the first time position coding.

20. The method according to claim 19, wherein a coding of the sensor data from the first channel is determined depending on the sensor data from the first channel, using the neural network, wherein the first input variable of the encoder is determined depending on the coding of the sensor data from the segment of the sensor data of the first channel and the first channel position coding and the first time position coding.

21. The method according to claim 19, wherein sensor data are determined from a segment of the predicted sensor data using the decoder, wherein a second time indication is assigned to the segment of the predicted sensor data, which characterizes a time period of the sensor data in the segment of the predicted sensor data, wherein a second time position coding is determined depending on the second time indication, using the same neural network with which the first time position coding is determined or using a second neural network, and wherein the second input variable of the decoder is determined depending on the second channel position coding and depending on the second time position coding.

22. The method according to claim 21, wherein a user input including the second time indication is detected.

23. The method according to claim 19, wherein the first time indication characterizes a start and an end of the time period, or time indication includes a time or time index which is assigned to the time period.

24. The method according to claim 15, wherein a reference for the predicted sensor data is provided, wherein: (i) the encoder and/or the decoder are trained depending on a difference between the reference and the predicted sensor data, and/or (ii) an anomaly is detected or a calibration is carried out depending on a difference between the reference and the predicted sensor data.

25. The method according to claim 15, wherein a user input including the predetermined text is detected.

26. The method according to claim 15, wherein the predicted time series is output.

27. An apparatus for processing time series of sensor data, comprising:
at least one processor; and
at least one memory;
wherein the at least one processor is configured to execute instructions, upon execution of which the apparatus executes a method, wherein the at least one memory stores the instructions, and wherein the method includes:
providing the sensor data in a first channel, wherein the first channel includes a first time series of the sensor data,
assigning a first text to the first channel, the first text characterizing the sensor data and/or a dimension of the sensor data in the first channel,
determining a first text coding depending on the first text, using a text encoder,
determining a first channel position coding depending on the first text coding, using a neural network,
determining a second text coding depending on a predetermined text,
using the text encoder, wherein the predetermined text characterizes sensor data to be predicted and/or a dimension of the sensor data to be predicted,
determining a second channel position coding depending on the second text coding, using the neural network,
determining a first input variable of an encoder depending on the sensor data from the first channel and depending on the first channel position coding,
determining a first input variable of a decoder, using the encoder,
depending on the first input variable of the encoder,
determining a second input variable of the decoder depending on the second channel position coding, and
predicting a time series of sensor data using the decoder depending on the first input variable of the decoder and the second input variable of the decoder.

28. A non-transitory computer-readable medium on which is stored a computer program including instructions for processing time series of sensor data, the method comprising the following steps:
providing the sensor data in a first channel, wherein the first channel includes a first time series of the sensor data;
assigning a first text to the first channel, the first text characterizing the sensor data and/or a dimension of the sensor data in the first channel;
determining a first text coding depending on the first text, using a text encoder;
determining a first channel position coding depending on the first text coding, using a neural network;
determining a second text coding depending on a predetermined text, using the text encoder, wherein the predetermined text characterizes sensor data to be predicted and/or a dimension of the sensor data to be predicted;
determining a second channel position coding depending on the second text coding, using the neural network;
determining a first input variable of an encoder depending on the sensor data from the first channel and depending on the first channel position coding;
determining a first input variable of a decoder, using the encoder, depending on the first input variable of the encoder;
determining a second input variable of the decoder depending on the second channel position coding; and
predicting a time series of sensor data using the decoder depending on the first input variable of the decoder and the second input variable of the decoder.
